(19) United States
(12) Patent Application Publication
(10) Pub. No.: US 2024/0218095 A1
(43) Pub. Date: Jul. 4, 2024

(54) PVDF FINE POWDERS

(71) Applicant: SOLVAY SPECIALTY POLYMERS ITALY S.P.A., Bollate (Milano) (IT)

(72) Inventors: Anne-Charlotte Le Gulluche, Milano (MI) (IT); Julio A. Abusleme, Saronno (Varese) (IT); Remi Joseph Sellier, Saronno (IT); Baptiste Gros, Lyon (FR)

(73) Assignee: SOLVAY SPECIALTY POLYMERS ITALY S.P.A., Bollate (Milano) (IT)

(21) Appl. No.: 18/557,565

(22) PCT Filed: Apr. 28, 2022
(86) PCT No.: PCT/EP2022/061427

§ 371 Date: Oct. 26, 2023

(30) Foreign Application Priority Data
Apr. 29, 2021 (EP) 21305550.2

(51) Int. Cl. C08F 14/22; H01M 4/62

(52) U.S. Cl. CPC C08F 14/22; H01M 4/623

(57) ABSTRACT

The invention relates to VDF polymer powders comprising primary particles having a median diameter in the range 15 to 50 microns and a total pore volume of 0.70 to 2.00 mL/g which are obtained by suspension polymerization. The powders can be used to form stable suspensions in water. The suspensions can be used in the preparation of articles such as components for batteries as well as membranes.

### TECHNICAL FIELD

This application claims priority to the European patent Application EP21305550.2, filed on 29 Apr. 2021, the whole content of this application being incorporated herein by reference for all purposes.

The present invention relates to a vinylidene fluoride polymer powder comprising round fine particles, to a process for manufacturing said vinylidene fluoride polymer powder and to articles prepared from the vinylidene fluoride polymer powder.

### BACKGROUND ART

Vinylidene fluoride polymers (hereinafter “VDF polymers”) are used in several applications in which VDF polymer's durability, chemical inertia and other advantageous properties are highly valuable. VDF polymers have found utility in architectural coatings, membrane manufacture, coating's for chemical industry and/or oil and gas (O & G) applications.

VDF polymers have also found widespread use as binders for the manufacture of electrodes, in particular cathodes, for the preparation of composite separators, and/or for coatings of porous separators for use in non-aqueous-type electrochemical devices such as batteries, preferably secondary batteries, and electric double layer capacitors.

VDF polymers are also employed for the preparation of fiber reinforced polymer composites, i.e. fiber-reinforced composite materials that use continuous fibers, e.g. carbon or glass fibers, as the primary structural component and a polymer, thermoset or thermoplastic, as the matrix component.

Several of the applications described above rely on the use of solvent- or water-based systems for the transformation of the VDF polymer into the final article.

VDF polymers are obtainable via polymerization of vinylidene fluoride monomers (difluoro 1,1-ethylene or VDF), either by suspension polymerization or by emulsion polymerization.

Post-processing emulsion-polymerized VDF polymers generally produces fine powders having larger surface area and porosity than suspension polymerized VDF polymers.

On the other hand, the higher porosity of the emulsion-polymerized VDF polymers often leads to swelling of the particles in a solvent or liquid that has some affinity with the PVDF and to VDF polymer dispersions of high viscosity. Consequently, the amount of VDF polymer particles that can be dispersed is limited by the viscosity of the system.

Suspension-polymerized VDF polymers are characterized by a denser particle structure than emulsion-polymerized VDF polymers. They are generally characterised by a larger average particle size which increases the tendency of the particles to settle when incorporated into a dispersion. While it is known to reduce the particle size by mechanical grinding, the resulting particles are characterized by irregular shapes.

Surprisingly it has been found that VDF polymer slurry mixtures having a good balance between high solid content and high stability, with respect to settling of the solids, can be prepared using VDF polymer powder comprising primary particles having a median particle diameter, d50, of from 15 to 50 microns and a total pore volume of 1.00 to 2.00 mL/g. The primary particles are further characterised by a rounded shape as hereinafter defined. The VDF polymer powder is obtained by suspension polymerization.

### SUMMARY OF INVENTION

In a first aspect, the invention relates to a VDF polymer powder comprising primary particles having a median particle diameter, d50, in the range of 15 to 50 microns, as measured by laser diffraction according to ISO 13320 and a total pore volume, Vpt, measured by mercury porosimetry, of 0.70 to 2.00 mL/g. In an embodiment of the invention the particles have a rounded shape. Preferably the primary particles have a Roundness Ratio, RR, from 0.70 to 1.00. In a further embodiment, the VDF polymer powder has been obtained by suspension polymerization.

A second aspect of the invention is a process for the manufacture of a VDF polymer powder comprising the step of polymerizing VDF in the presence of a polyvinyl alcohol suspending agent under vigorous stirring.

A further aspect of the invention is a slurry comprising water and the VDF polymer powder which is the first aspect of the invention.

### BRIEF DESCRIPTION OF DRAWINGS

FIG. 1 is a scanning electron microscope image of the VDF polymer powder of Example 7.

FIG. 2 is a scanning electron microscope image of the VDF Polymer A.

### DESCRIPTION OF INVENTION

### Definitions

Contrary to the use of“consisting”, the use of “including,” “containing”, “comprising,” or “having” and variations thereof is meant to encompass the items listed thereafter as well as additional items. The use of “a” or “an” is meant to encompass “one or more”. Any numerical range recited herein describing a physical property or a concentration is intended to include all values from the lower value to the upper value of that range and including the endpoints. For example, a concentration range of from 1% to 50% is intended to be an abbreviation and to expressly disclose the values between the 1% and 50%.

For the purpose of the present invention, by “primary particle” it is intended to denote the smallest discrete identifiable entity observable by laser diffraction technique performed according to ISO 13320.

Primary particles are to be intended distinguishable from agglomerates, that is clusters of primary particles held together by weak physical interactions, obtained at the end of the polymerization of the VDF monomer which are separated from the reactor liquor, washed and then dried.

The term “Span” is used herein to refer to the width of the primary particle size distribution defined as the ratio (d90-d10)/d50, wherein:
d50 is the median particle diameter and it represents the particle diameter below (and above) which 50% of the total volume of particles is found;
d10 represents the particle diameter below which 10% of the total volume of particles is found; and
d90 represents the particle diameter below which 90% of the total volume of particles is found.

For the avoidance of doubt, in the present text the values d10, d50 and d90 refer to the diameter of primary particles of the VDF polymer.

The first object of the invention is thus a VDF polymer powder comprising primary particles having a median particle diameter, d50, from 15 to 50 microns, as measured by laser diffraction according to ISO 13320 and a total pore volume, Vpt, measured by mercury porosimetry, of 0.70 to 2.00 mL/g.

As used herein, the term “VDF polymer” indicates a polymer comprising more than 80 mol %, preferably more than 85 mol %, even more than 90 mol %, of recurring units derived from the polymerization of vinylidene fluoride monomer (difluoro 1,1-ethylene, VF2 or VDF).

The VDF polymer may be a homopolymer, that is a polymer comprising only recurring units derived from VDF.

Alternatively, the VDF polymer may comprise, in addition to the VDF monomer, recurring units different from VDF ones, and which are derived from the polymerization of ethylenically unsaturated monomers different from VDF.

Said ethylenically unsaturated monomers different from VDF may be selected from the group consisting of fluorinated monomers or non-fluorinated monomers.

Fluorinated monomers are ethylenically unsaturated monomers which comprise at least one fluorine atom.

Non-limiting examples of fluorinated monomers different from VDF comprise, notably, the following:
(i) C2-C8 fluoroolefins such as trifluoroethylene (TrFE), tetrafluoroethylene (TFE) and hexafluoropropylene (HFP);
(ii) perfluoroalkylethylenes of formula CH₂═CH—Rf₀, wherein Rf₀ is a C2-C6 perfluoroalkyl group;
(iii) chloro- and/or bromo- and/or iodo-C2-C6 fluoroolefins such as chlorotrifluoroethylene (CTFE);
(iv) perfluoroalkylvinylethers of formula CF₂═CFORf₁, wherein Rf₁ is a C1-C6 perfluoroalkyl group, such as perfluoromethylvinylether (PMVE) and perfluoropropylvinylether (PPVE);
(v) (per)fluorooxyalkylvinylethers of formula CF₂═CFOX₀, wherein X₀ is a C1-C12 oxyalkyl group or a C1-C12 (per)fluorooxyalkyl group having one or more ether groups, e.g. perfluoro-2-propoxy-propyl group;
(vi) (per)fluoroalkylvinylethers of formula CF₂═CFOCF₂ORf₂, wherein Rf₂ is a C1-C6 (per)fluoroalkyl group, e.g. —CF₃, —C₂F₅, —C₃F₇, or a C1-C6 (per)fluorooxyalkyl group having one or more ether groups, e.g. —C₂F₅—O—CF₃;
(vii) functional (per)fluorooxyalkylvinylethers of formula CF₂═CFOY₀, wherein Y₀ is selected from a C1-C12 alkyl group or (per)fluoroalkyl group, a C1-C12 oxyalkyl group and a C1-C12 (per)fluorooxyalkyl group having one or more ether groups, Y₀ comprising a carboxylic or sulfonic acid group, in its acid, acid halide or salt form;
(viii) fluorodioxoles, especially perfluorodioxoles;
(ix) vinyl fluoride,
and their mixtures.

Most preferred fluorinated comonomers are chlorotrifluoroethylene (CTFE), trifluoroethylene (TrFE), tetrafluoroethylene (TFE), hexafluoropropylene (HFP), perfluoromethylvinylether (PMVE).

The VDF polymer may comprise from 0.1 to 15.0 mol % of a fluorinated monomer different from VDF, with respect to the total number of moles of the polymer.

Preferably the VDF polymer is semi-crystalline and comprises from 0.1 to 10.0 mol %, preferably from 0.3 to 5.0 mol %, more preferably from 0.5 to 3.0 mol % of recurring units derived from a fluorinated monomer different from VDF.

It is understood that chain ends, defects or other impurity-type moieties might be comprised in the VDF polymer without these impairing its properties.

In alternative or in addition to recurring units derived from a fluorinated monomer different from VDF, the VDF polymer may comprise recurring units derived from an ethylenically unsaturated monomer free from fluorine atoms. Examples of non-fluorinated monomers are notably hydrophilic monomers of Formula (I), hereinafter “hydrophilic monomer”:

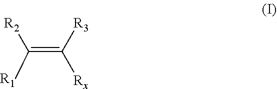

wherein:
R₁, R₂ and R₃, equal to or different from each other, are independently selected from a hydrogen atom and a C₁-C₃ hydrocarbon group, and
Rₓ is a C₁-C₂₀ hydrocarbon moiety comprising at least one functional group selected from a hydroxyl, a carboxyl, an epoxide, an ester and an ether group.

In an embodiment, the hydrophilic monomer is a monomer of Formula (I) as above defined, wherein Rₓ is a C₁-C₅ hydrocarbon moiety comprising at least one carboxyl group.

In another embodiment, the hydrophilic monomer is selected from the compounds of Formula (Ia):

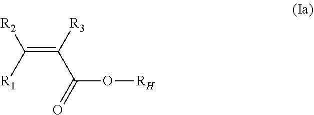

wherein
R₁, R₂ and R₃, equal to or different from each other, are independently selected from a hydrogen atom or a C₁-C₃ hydrocarbon group, and
RH is a hydrogen or a C₁-C₅ hydrocarbon moiety comprising at least one carboxyl group.

Non-limiting examples of monomers of Formula (Ia) include, notably acrylic acid, (meth)acrylic acid, and mixtures thereof.

In a further embodiment, the hydrophilic monomer is selected from compounds of Formula (Ib):

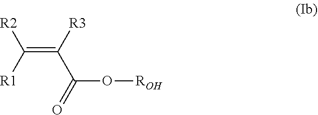

wherein each of R1, R2, R3, equal or different from each other, is independently a hydrogen atom or a C1-C3 hydrocarbon group, and R_{OH} is a hydrogen or a C1-C5 hydrocarbon moiety comprising at least one hydroxyl group. Non limiting examples of hydrophilic monomers of Formula (Ib) are hydroxyethyl (meth)acrylate, hydroxypropyl(meth)acrylate; hydroxyethylhexyl (meth)acrylates.

The hydrophilic monomer is advantageously selected from the group consisting of:
hydroxyethylacrylate (HEA) of formula:

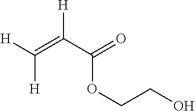

2-hydroxypropyl acrylate (HPA) of either of formulae:

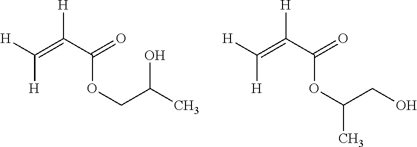

and mixtures thereof.

The hydrophilic monomer is preferably randomly distributed into the VDF polymer.

The VDF polymer may comprise at least 0.02 mol %, more preferably at least 0.20 mol % of recurring units derived from a hydrophilic monomer.

The VDF polymer comprises preferably at most 5.0 mol %, more preferably at most 3.0 mol %, even more preferably at most 1.5 mol % of recurring units derived from a hydrophilic monomer.

In one embodiment of the present invention, the VDF polymer preferably comprises, more preferably consists of recurring units derived from:
at least 80.00 mol %, preferably at least 85.00 mol %, more preferably at least 90.00 mol % of vinylidene fluoride (VDF),
from 0.01 mol % to 3.00 mol %, preferably from 0.05 mol % to 1.50 mol %, more preferably from 0.15 mol % to 1.0 mol % of a hydrophilic monomer of Formula (I) as above defined, including those of Formula (Ia) and (Ib);
optionally from 0.50 mol % to 3.00 mol % of recurring units derived from a fluorinated monomer different from VDF.

The VDF polymer powder of the invention comprises primary particles having a median particle diameter, d50, from 15 to 50 microns, as measured by laser diffraction according to ISO 13320.

The VDF polymer powder comprises primary particles having a median particle diameter, d50, greater than 15 microns, preferably greater than 20 microns and/or lower than 50 microns, preferably lower than 49 microns, even lower than 45 microns. In an advantageous embodiment the VDF powder typically comprises primary particles having a median particle diameter, d50, from 20 to 50 microns, from 20 to 49 microns, from 22 to 40 microns, and even from 22 to 35 microns.

The VDF polymer powder conveniently has a Span of the primary particle size distribution which is less than 2.0, even less than 1.5.

The VDF polymer powder comprises primary particles which are characterised by a total pore volume, measured by mercury porosimetry as described in detail hereafter, of 0.70 to 2.00 mL/g. The total pore volume may be greater than 0.75 mL/g, even greater than 0.80 mL/g.

In one embodiment of the invention the VDF polymer primary particles have a rounded shape. Preferably they have a Roundness Ratio, RR, from 0.70 to 1.00, preferably from 0.75 to 1.00.

The Roundness Ratio, RR, is defined as the ratio between the minimum Feret's diameter and the maximum Feret's diameter, wherein the Feret's diameter is defined as the distance between two parallel tangents on opposite sides of a particle's silhouette.

A Roundness Ratio close to 1.00 implies a very round particle. On the other hand, a Roundness Ratio close to zero identifies a non rounded particle similar to a fibre shape.

Roundness Ratio was determined by image analysis on pictures taken with a scanning electron microscope Jeol JSM-7610F, with an accelerating voltage tuned at 5 kV; pictures size: 1280×1024 pixels. The image analysis was performed with Zen ZEISS Software provided with “Image Analysis” and “Intellesis” modules, as described in the Experimental Section.

The VDF polymer powder according to the invention comprises at least 55%, preferably 65%, more preferably 75% by number of primary particles having a Roundness Ratio greater than 0.80.

The VDF polymer powder has been obtained by suspension polymerization.

A second object of the invention is a process for making the VDF polymer powder which is the first object of the invention.

The process of the invention is a polymerization carried out in aqueous suspension.

In one embodiment the process for the preparation of the VDF polymer powder comprises the step of polymerizing VDF and optionally one or more ethylenically unsaturated monomer copolymerizable therewith in an aqueous suspension in the presence of a water soluble suspending agent selected from the group of partially hydrolysed polyvinylalcohol polymers, said polymerization being carried out in a reactor under stirring characterised in that for a given reactor diameter D (expressed in meters) the stirring speed N (expressed in rpm) is such that:

$${\vert D \vert}^{2 / 3} \times \vert N \vert \geq 250$$

wherein |D| represents the absolute value of reactor's diameter D expressed in meters and |N| represents the absolute value of the stirring speed expressed in rpm.

In a preferred embodiment stirring speed N is such that:

$${\vert D \vert}^{2 / 3} \times \vert N \vert \geq 270 .$$

The upper value of stirring speed N is limited only by the configuration of the system, but the expression |D|^{2/3}×|N| as defined above does not generally exceed 1000, it does not generally exceed 800, even it does not generally exceed 700.

In an embodiment of the process the expression |D|^{2/3}×|N| has been found to be advantageously comprised between 250 and 600, even between 270 and 500, in some instances between 270 and 400.

In another embodiment the process for the preparation of the VDF polymer powder comprises the step of polymerizing VDF and optionally one or more ethylenically unsaturated monomer copolymerizable therewith in an aqueous suspension in the presence of a water soluble suspending agent selected from the group of partially hydrolysed polyvinylalcohol polymers, said polymerization being carried out in a reactor under stirring characterised in that—the rate of stirring is such that the Reynolds number Re=ρ·N·d_{I}²/μ, wherein ρ is the density of water (kg/m³), N the number of revolutions per second of the impeller (1/s), d_{I} the diameter of the impeller (m) and u the dynamic viscosity of water (Pa·s) at the temperature of the reaction, is greater than 24000, preferably greater than 25000, more preferably greater than 27000, even more preferably greater than 30000. The maximum Reynolds number is not particularly limited, in general it is preferably lower than 100000, more preferably lower than 90000, even more preferably lower than 50000.

For the purpose of the present invention, by polymerization in aqueous suspension it is meant a process wherein the reaction medium is formed by an organic phase, to which water is added. Water is typically added in order to favor the heat dispersion developing during the reaction. The organic phase can be formed by the monomer(s) themselves, without addition of solvents, or by the monomer(s) dissolved in a suitable organic solvent, in the presence of a suitable organic initiator and of a water soluble suspending agent.

Water soluble suspending agents suitable for the process of the invention are partially hydrolysed polyvinyl alcohol polymers. The expression “partially hydrolysed polyvinyl alcohol polymer” is used herein to refer to polymers obtained by the partial hydrolysis of poly(vinyl acetate) polymers. Poly(vinyl acetate) polymers are defined as polymers consisting of recurring units derived from vinyl acetate.

The partially hydrolysed poly(vinyl alcohol) polymer is generally a composition comprising partially hydrolysed poly(vinyl acetate) and poly(vinyl alcohol).

Partially hydrolysed poly(vinyl alcohol) polymers are commercially available and may be obtained over a range of molecular weights and degree of hydrolysis.

The degree of hydrolysis of the partially hydrolysed poly(vinyl alcohol) polymer used in the process of the present invention is generally at least 50%, preferably at least 55%.

The amount of the at least one partially hydrolysed poly(vinyl alcohol) polymer used in the polymerization is typically between 0.1 and 2.0 g/Kg of total monomers, preferably between 0.5 and 1.5 g/Kg of total monomers.

The polymerization reaction can be carried out in conditions of temperature and pressure such that the more abundant monomer, namely VDF, is present in subcritical or supercritical conditions.

More preferably the polymerization is performed with a water/monomer (g/g) initial ratio (hereinafter “Rwm”) higher than 3.00, preferably higher than 5.00.

Typically the process of the invention is carried out at a temperature of at least 10° C., preferably of at least 25° C., more preferably of at least 45° C.

The pressure is typically maintained at a value of more than 2.5 MPa, preferably of more than 5.0 MPa, even more preferably of more than 7.5 MPa.

The process of the invention is carried out in the presence of a radical initiator. While the choice of the radical initiator is not particularly limited, it is understood that those initiators suitable for the process according to the invention are selected from compounds capable of initiating and/or accelerating the polymerization process.

Among radical initiators that may advantageously be used in the process of the invention, mention can be made of organic radical initiators. Non-limiting examples of suitable organic radical initiators include, but are not limited to, the following: acetylcyclohexanesulfonyl peroxide; diacetylperoxydicarbonate; dialkylperoxydicarbonates such as diethylperoxydicarbonate, dicyclohexylperoxydicarbonate, di-2-ethylhexylperoxydicarbonate; tert butylperneodecanoate; 2,2′-azobis(4-methoxy-2,4dimethylvaleronitrile; tert butylperpivalate; tert-amylperpivalate; dioctanoylperoxide; dilauroyl-peroxide; 2,2′-azobis (2,4 dimethylvaleronitrile); tert-butylazo-2-cyanobutane; dibenzoylperoxide; tert-butyl-per-2ethylhexanoate; tert-butylpermaleate; 2,2′-azobis(isobutyronitrile); bis(tert-butylperoxy)cyclohexane; tert-butyl-peroxyisopropylcarbonate; tert-butylperacetate; 2,2′-bis (tert-butylperoxy)butane; dicumyl peroxide; di-tert-amyl peroxide; di-tert-butyl peroxide (DTBP); p-methane hydroperoxide; pinane hydroperoxide; cumene hydroperoxide; and tert-butyl hydroperoxide.

The process of the invention typically further comprises separating the VDF polymer obtained at the end of the polymerization step from the aqueous medium. Separation is typically performed by filtration.

The VDF polymer obtained by the process of the invention is typically dried, typically at a temperature comprised between 30° C. and 120° C., preferably between 50° C. and 90° C.

The Applicant has surprisingly found that the process according to the present invention allows obtaining a VDF polymer in the form of primary particles having a median particle diameter, d50, from 15 to 50 microns and a total pore volume, Vpt, of 0.70 to 2.00 mL/g.

The processes of the prior art allowed obtaining particles having a size distribution with a d50 value lower than 50 microns and a pore volume in the 0.70 to 2.00 mL/g range typically by a milling process of larger VDF polymer particles. However, this process is very time and energy consuming. Furthermore the particles obtained by milling are not round.

A further object of the invention is a composition comprising water and the VDF polymer primary particles which are the first object of the invention. The VDF polymer primary particles of the invention are easily suspended in water by using any suitable non-ionic surfactant with very little decantation over time. It has been surprisingly found that aqueous compositions which are stable over time, that is do not give rise to the settlin of the particles, can be obtained regardless of the generally dense nature of the primary particles when the particles have a d50 in the 15 to 50 microns range.

The composition may additionally comprise a surfactant, generally a non-ionic surfactant. Other additives as densifiers or stabilizers of the dispersion may be used.

Preferably, the composition comprises from 20 wt. % to 60 wt. % of the inventive primary particles over the total weight of the composition, more preferably from 45 wt. % to 55 wt. %.

The VDF polymers powders of the invention, and the liquid compositions comprising said VDF polymers powders can be used for the manufacture of numerous articles.

In an embodiment said powders and compositions may be used for the manufacture of binders and electrodes for primary and secondary batteries.

The VDF polymers powders of the invention are also particularly suitable for the preparation of film and membranes. Among membranes, mention may be made of porous membranes, in particular porous membranes for water filtration.

The VDF polymer powders of the invention may also be conveniently employed for the preparation of fiber reinforced composite materials.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### Analytical Methods

The properties of the VDF polymer powder of the invention were determined using the methods described hereafter.

### Determination of Pore Volume by Mercury Porosimetry

Pore volume and pore size distribution were determined using a Micromeritics AutoPore® IV 9520 porosimeter; they were calculated by the Washburn relationship with a contact angle theta equal to 140° and a surface tension gamma equal to 485 dynes/cm. Each sample was treated before the measure in an oven at 200° C. for 2 hours at atmospheric pressure. The starting weight of the sample placed in the type 10 penetrometer, having an accuracy of 0.001 g, was about 200 mg.

The AutoPore® equipment was operated using Software Version IV 1.09. No corrections were performed on the raw data. The measurement range was from 3.59 kPa (0.52 psi) to 413685 kPa (60000 psi).

The Log Differential Intrusion (mL/g) versus pore size data was analysed in the pore diameter range from 3.5 nm to 405 μm.

### Particle Size Analysis

Particle size analysis of the powder was carried out using laser diffraction according to norm ISO 13320.

### Determination of the Roundness Ratio (RR)

Scanning Electron Microscopy (SEM) pictures were obtained with a scanning electron microscope Jeol JSM-7610F, with an accelerating voltage tuned at 5 kV. The particles were stuck on a stub covered with a double-sided graphite tape, then metal coated with a layer of Iridium, 8 nm thick. The image analysis was performed with Zen ZEISS Software. ZEN Zeiss software includes “Image Analysis” and “Intellesis” modules.

All parameters are described below for each steps of processing.

### SEM Pictures Size is 1280×1024 Pixels

### 1. “Intellesis Trainable Segmentation”

This module is used to define the countour of particules by the mean of machine learning system. A simultaneous training on two images, each from spherical and non spherical SEM photographs, was carried out.

### Parameters: Segmentation=Basic Features 33—Postprocessing=No

### 2. “Image Analysis”—Setup

This step allows further setups to improve the model of segmentation, adapt it to the pictures of interest, and specify the type of results.
Parameters: Classes=2—Frame rectangular: Left=0; Top=0;
Width=1280; Height=950; Angle=0—Automatic segmentation: minimum Area=1; min. Hole Area=1; Fill Holes=Yes; Binary=None; Separate=Watersheds; Count=7; Min.Conf.=0—Region Filter: BoundBottom (Max=949); BoundLeft (Min=0); BoundRight (Max=1279); BoundTop (Min=0)—Features: Ratio Feret

### 3. “Image Analysis”—Analyze

On this final step, all the previous parameters were applied on the pictures of interest. Data are shown on the software, then saved in .csv format.

### Raw Materials

Polymer A: VDF/HFP copolymer (85/15 wt/wt) was prepared as described in US 2003/0176608A1.
PVA-1: high molecular weight hydrolysed poly(vinyl alcohol), degree of hydrolysis 80%—commercially available under the name Alcotex® 80 (Synthomer).
PVA-2: high molecular weight hydrolysed poly(vinyl alcohol), degree of hydrolysis 72.5%—commercially available under the name Alcotex® 72.5 (Synthomer).
PVA-3: high molecular weight hydrolysed poly(vinyl alcohol), degree of hydrolysis 55%—commercially available under the name Alcotex® 552P (Synthomer).
DA1: hydroxypropyl methylcellulose ether, commercialized by Dow
Chemical under the name Methocel® K100GR, having a dynamic viscosity of 80-120 mPa·s at 20° C. in an aqueous solution at a concentration of 2 wt %.
DCE: Diethyl Carbonate from Sigma Aldrich.

### Example 1

In a 4L reactor were introduced in sequence 2046 g of demineralized water and 1 g of PVA-1 per kg of total VDF monomer. The mixture was stirred with a six-blades rotary impeller running at a speed of 1300 rpm.

The oxygen present in the reactor was removed with a sequence vacuum/nitrogen at a fixed temperature of 20° C. The sequence was repeated 3 times.

Then, 71.07 g of DCE and 2.27 g of a solution of t-amylperpivalate (from United Initiators) in isododecane (75%) were introduced in the reactor.

1282 g of VDF were added to the mixture (Rwm=1.59). The reactor was then gradually heated until the first set point temperature of 52° C. was reached. At this temperature, the pressure of the reactor was fixed at 12 MPa.

The pressure was kept constant at 12 MPa by feeding 640 g of VDF. After this feeding, no more monomer was fed and the pressure started to decrease down to 8 MPa. A total of 1921 g of VDF were charged in the reactor. Then, the temperature of the reactor was gradually raised to 65° C. The pressure was kept at 90 MPa then was decreased to 5 MPa and the polymerization was stopped by degassing the suspension until reaching atmospheric pressure. The polymer was then collected by filtration and suspended against clean water in a stirred tank. After the washing treatment, the polymer was dried in an oven at 65° C. for twelve hours. 1677 g of dry powder were collected.

Polymerization time and particle characterization are shown in Table 1.

### Example 2

In a 4L reactor were introduced in sequence 2180 g of demineralized water and 1.5 g of PVA-1 per kg of total VDF monomer. The mixture was stirred with an impeller running at a speed of 1300 rpm.

The oxygen present in the reactor was removed with a sequence vacuum/nitrogen at a fixed temperature of 20° C. The sequence was repeated 3 times.

Then, 64.68 g of DCE and 1.55 g of a solution of t-amylperpivalate (from United Initiators) in isododecane (75%) were introduced in the reactor.

1176 g of VDF were added to the mixture (Rwm=1.85). The reactor was then gradually heated until the first set point temperature of 52° C. was reached. At this temperature, the pressure of the reactor was fixed at 12 MPa.

The pressure was kept constant at 12 MPa by feeding 794 g of demineralized water. After 300 minutes, the polymerization was stopped by degassing the suspension until reaching atmospheric pressure. The polymer was then collected by filtration and suspended against clean water in a stirred tank. After the washing treatment, the polymer was dried in an oven at 65° C. for twelve hours. 901 g of dry powder were collected.

Polymerization time and particle characterization are provided in Table 1.

### Example 3

In a 4L reactor were introduced in sequence 3129 g of demineralized water and 1.5 g of PVA-1 per kg of total VDF monomers. The mixture was stirred with an impeller running at a speed of 1300 rpm.

The oxygen present in the reactor was removed with a sequence vacuum/nitrogen at a fixed temperature of 20° C. The sequence was repeated 3 times.

Then, 23.08 g of DCE and 0.67 g of a solution of t-amylperpivalate (from United Initiators) in isododecane (75%) were introduced in the reactor.

510 g of VDF were added to the mixture (Rwm=6.14). The reactor was then gradually heated until the first set point temperature of 52° C. was reached. At this temperature, the pressure of the reactor was fixed at 12 MPa.

The pressure was kept constant at 12 MPa by feeding 351 g of demineralized water. After 300 minutes, the polymerization was stopped by degassing the suspension until reaching atmospheric pressure. The polymer was then collected by filtration and suspended against clean water in a stirred tank. After the washing treatment, the polymer was dried in an oven at 65° C. for twelve hours. 386 g of dry powder were collected. Polymerization time and particle characterization are detailed in Table 1.

### Example 4

The same procedure of Example 3 was followed, but using but using 1.5 g of PVA-2 per kg of total VDF monomers (Rwm=6.14). 370 g of dry powder were collected. Polymerization time and particle characterization are detailed in Table 1.

### Example 5 (Comparative)

The same procedure of Example 1 was followed, but replacing PVA-1 with 0.4 g of DA1 per kg of total VDF monomers (Rwm=1.59). 1706 g of dry VDF polymer powder were collected. Polymerization time and particle characterization are reported in Table 1.

### Example 6 (Comparative)

The same procedure of Example 1 was followed, but using a stirring speed of 880 rpm (Rwm=1.59). 1678 g of dry VDF polymer powder were collected. Polymerization time and particle characterization are reported in Table 1.

### Example 7

In a 4L reactor were introduced in sequence 3119 g of demineralized water and 0.76 g of PVA-1 per kg of total monomers The mixture was stirred with an impeller running at a speed of 1300 rpm.

The oxygen present in the reactor was removed with a sequence vacuum/nitrogen at a fixed temperature of 20° C. The sequence was repeated 3 times.

Then, 0.22 g of acrylic acid and 1.92 g of a solution of t-amylperpivalate (from United Initiators) in isododecane (75%) were introduced in the reactor. Immediately after, 504 g of VDF were added to the mixture (Rwm=6.17). The reactor was then gradually heated until the set point temperature of 55° C. was reached, corresponding to a pressure of 12 MPa.

The pressure was kept constant at 12 MPa during the whole polymerization run by feeding an aqueous solution comprising 13.54 g of acrylic acid per liter of solution. After 386 minutes the polymerization was stopped by degassing the suspension until reaching atmospheric pressure. A total of 331 g of acrylic acid solution was charged to the reactor.

The polymer was then collected by filtration and suspended against clean water in a stirred tank. After the washing treatment, the polymer was dried in an oven at 65° C. for twelve hours. 395 g of dry powder were collected. Polymerization time and particle characterization are detailed in Table 1.

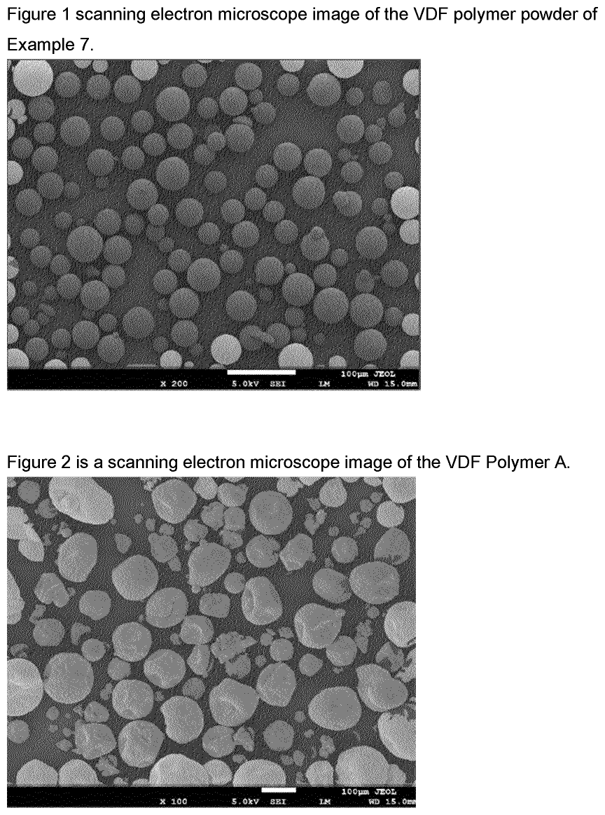

A SEM picture of the polymer particles is provided in FIG. 1. The amount of particles with RR higher than 0.80 is 84%.

FIG. 2 shows Polymer A for comparison where the size and the shape of the particles are out of the invention and the percentage of particles having a RR value higher than 0.80 is 45%.

### Example 8 (Comparative)

The same procedure of Example 2 was followed, but using but using 0.4 g of DA1 per kg of total VDF monomers (Rwm=1.85) and setting a stirring speed of 880 rpm. 833 g of dry VDF polymer powder were collected. Polymerization time and particle characterization in are provided in Table 1.

### Example 9

The same procedure of Example 3 was followed, but using 0.5 g of PVA-1 per kg of total VDF monomers and 1.0 g of PVA-3 per kg of total VDF monomers. Rwm was 6.18. 375 g of dry powder were collected. Polymerization time and particle characterization in Table 1.

TABLE 1

| | | | | | Total | |
|---|---|---|---|---|---|---|
| | | | | | pore | Polymer- |
| | Dispersing | \|D\|^{2/3} × | d50 | | volume | ization |
| Sample | Agent | \|N\| | (μm) | Span | (mL/g) | duration |
| Example 1 | PVA-1 | 323 | 46 | 1.31 | 1.21 | 6 h 22 |
| Example 2 | PVA-1 | 323 | 42 | 0.97 | | 5 h 02 |
| Example 3 | PVA-1 | 323 | 32 | 1.37 | | 5 h 02 |
| Example 4 | PVA-2 | 323 | 28 | 1.27 | | 5 h 03 |
| Example 5 - | DA1 | 323 | 59 | 0.88 | | 6 h 13 |
| comparative | | | | | | |
| Example 6 - | PVA-1 | 219 | 84 | 0.86 | 1.19 | 6 h 06 |
| comparative | | | | | | |
| Example 7 | PVA-1 | 323 | 38 | 1.00 | | 6 h 26 |
| Example 8 | DA1 | 219 | 90 | 0.72 | | 5 h 02 |
| comparative | | | | | | |
| Example 9 | PVA-3 | 323 | 47 | 0.91 | | 5 h 03 |

### Example 10: Stability of VDF Polymer Powder Suspensions

20 g of the VDF polymer powder prepared in Example 4 (d50=28 microns) were poured into a transparent flask, under ambient air at room temperature. Then, 100 g of an aqueous solution of DA1 (1 wt % concentration) were added into the flask and the mixture was stirred vigorously. Once the powder was dispersed in the aqueous solution, stirring was stopped and the stability of the suspension was monitored every 5 minutes. After 30 minutes no settling of VDF polymer particles was observed.

The experiment was performed using 20 g of the VDF polymer powder prepared in comparative Example 8 (d50=90 microns). The suspension was found to be unstable and two phases were clearly observed five minutes after stirring was stopped.

1. A VDF polymer powder comprising primary particles having a median particle diameter, d50, from 15 to 50 microns, as measured by laser diffraction according to ISO 13320, and a total pore volume, of 0.70 to 2.00 mL/g, wherein primary particles are defined as the smallest discrete identifiable entity observable by laser diffraction technique performed according to ISO 13320 and pore volume is determined by mercury porosimetry.

2. The VDF polymer powder of claim 1 wherein the primary particles have a rounded shape.

3. The VDF polymer powder of claim 1 wherein at least 55% by number of primary particles have a Roundness Ratio greater than 0.8, wherein the Roundness Ratio is defined as the ratio between the minimum Feret's diameter and the maximum Feret's diameter, wherein the Feret's diameter is defined as the distance between two parallel tangents on opposite sides of a particle's silhouette as determined by image analysis.

4. The VDF polymer powder of claim 1 wherein the VDF polymer comprises recurring units derived from VDF and optionally recurring units derived from the polymerization of one or more ethylenically unsaturated monomer different from VDF.

5. The VDF polymer powder of claim 4 wherein the ethylenically unsaturated monomer different from VDF is selected from the group consisting of fluorinated monomers, non-fluorinated monomers and mixtures thereof.

6. The VDF polymer powder of claim 5 wherein the fluorinated ethylenically unsaturated monomer is selected from the group consisting of:
(i) C2-C8 fluoroolefins;
(ii) perfluoroalkylethylenes of formula CH₂═CH—Rf₀, wherein Rf₀ is a C2-C6 perfluoroalkyl group;
(iii) chloro- and/or bromo- and/or iodo-C2-C6 fluoroolefins;
(iv) perfluoroalkylvinylethers of formula CF₂═CFORf₁, wherein Rf₁ is a C1-C6 perfluoroalkyl group;
(v) (per)fluorooxyalkylvinylethers of formula CF₂═CFOX₀, wherein X₀ is a C1-C12 oxyalkyl group or a C1-C12 (per)fluorooxyalkyl group having one or more ether groups;
(vi) (per)fluoroalkylvinylethers of formula CF₂═CFOCF₂ORf₂, wherein Rf₂ is a C1-C6 (per)fluoroalkyl group or a C1-C6 (per)fluorooxyalkyl group having one or more ether groups;
(vii) functional (per)fluorooxyalkylvinylethers of formula CF₂═CFOY₀, wherein Y₀ is selected from a C1-C12 alkyl group or (per)fluoroalkyl group, a C1-C12 oxyalkyl group and a C1-C12 (per)fluorooxyalkyl group having one or more ether groups, Y₀ comprising a carboxylic or sulfonic acid group, in its acid, acid halide or salt form;
(viii) fluorodioxoles;
(ix) vinyl fluoride,
and their mixtures.

7. The VDF polymer powder of claim 5 wherein the ethylenically unsaturated non-fluorinated monomer is selected from hydrophilic monomers of Formula (I): 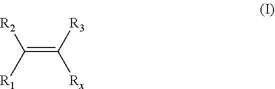
wherein:
R₁, R₂ and R₃, equal to or different from each other, are independently selected from a hydrogen atom and a C₁-C₃ hydrocarbon group, and
Rₓ is a C₁-C₂₀ hydrocarbon moiety comprising at least one functional group selected from a hydroxyl, a carboxyl, an epoxide, an ester and an ether group.

8. A process for the preparation of the VDF polymer powder of claim 1, said process comprising the step of polymerizing VDF and optionally one or more ethylenically unsaturated monomer copolymerizable therewith in an aqueous suspension in the presence of a water soluble suspending agent selected from the group of partially hydrolysed poly(vinyl alcohol) polymers, said polymerization being carried out in a reactor under stirring characterised in that for a given reactor diameter D the stirring speed N is such that:
$${\vert D \vert}^{2 / 3} \times \vert N \vert \geq 250$$
wherein |D| represents the absolute value of reactor's diameter D expressed in meters and |N| represents the absolute value of the stirring speed expressed in rpm.

9. The process of claim 8 wherein
$$250 \leq ( {\vert D \vert}^{2 / 3} \times \vert N \vert ) \leq 600 .$$

10. A process for the preparation of the VDF polymer powder of claim 1, said process comprising the step of polymerizing VDF and optionally one or more ethylenically unsaturated monomer copolymerizable therewith in an aqueous suspension in the presence of a water soluble suspending agent selected from the group of partially hydrolysed poly(vinyl alcohol) polymers, said polymerization being carried out in a reactor under stirring characterised in that the rate of stirring is such that the Reynolds number Re=ρ·N·d_{I}²/μ, wherein ρ is the density of water (kg/m³), N the number of revolutions per second of the impeller (1/s), d_{I} the diameter of the impeller (m) and μ the dynamic viscosity of water (Pa·s) at the temperature of the reaction, is greater than 24000.

11. The process of claim 8 wherein the partially hydrolysed poly(vinyl alcohol) polymer has a degree of hydrolysis of at least 50%.

12. A composition comprising water and the VDF polymer powder of claim 1.

13. The composition of claim 12 comprising from 20 wt. % to 60 wt. % of the VDF polymer powder over the total weight of the composition.

14. An article formed from the VDF polymer powder of claim 1.

15. The article of claim 14, wherein the article is a membrane or a fiber reinforced composite material.

16. The article of claim 14, wherein the article is a binder or electrode for primary and secondary batteries.
